(19) United States
(12) Patent Application Publication
(10) Pub. No.: US 2023/0396910 A1
(43) Pub. Date: Dec. 7, 2023

(54) WEARABLE EAR SPEAKER WITH FIVEFOLD ADJUSTABILITY

(71) Applicant: Conquest Systems, Inc., Atlanta, GA (US)

(72) Inventors: Raghu Bathina, Los Altos Hills, CA (US); Sridhar Prathikanti, Burlingame, CA (US); Noah McNeely, Grayson, GA (US)

(21) Appl. No.: 17/805,227

(22) Filed: Jun. 2, 2022

(51) Int. Cl. H04R 1/10

(52) U.S. Cl. CPC H04R 1/1008; H04R 2499/15; H04R 1/1066; H04R 1/105

(57) ABSTRACT

A wearable ear speaker is provided. Speaker comprises an earpiece comprising a body defining a housing, and internal electronics mounted within said housing for converting an electrical signal into sound; an arm defining a boom for the earpiece; and a mount for mounting the earpiece to the arm; wherein said mount comprises a removable attachment comprising an operatively outer surface for bearing indicia.

### FIELD

Embodiments of the present invention relates to ear speakers.

### BACKGROUND

Wearable ear speakers, for example in the form of headphones, are commonly used for audio reproduction in association with electronic devices such as music players, et cetera.

### SUMMARY

According to a first aspect of the invention there is provided a wearable ear speaker, comprising: an earpiece comprising a body defining a housing, and internal electronics mounted within said housing, wherein said body comprises a removable attachment comprising an operatively outer surface for bearing indicia; arm defining a boom for the earpiece; and a mounting formation for mounting the earpiece to said boom.

According to a second aspect of the invention there is provided wearable ear speaker, comprising: an earpiece comprising a body defining a housing, and internal electronics mounted within said housing for converting an electrical signal into sound; an arm defining a boom for the earpiece; and a slidable mount for mounting the earpiece to the arm.

According to a third aspect of the invention there is provided wearable ear speaker, comprising: wearable ear speaker, comprising: an earpiece comprising a body defining a housing, and internal electronics mounted within said housing for converting an electrical signal into sound; a mounting arm defining a boom for the earpiece comprises a control mechanism to control a clearance of the earpiece relative to a wearer's ear; a mount for mounting the earpiece to the arm; and a rotatable clamp for securing said mounting arm to the head mount for a virtual reality device.

Other aspects of the invention will be apparent from the detailed description below.

### BRIEF DESCRIPTION OF THE DRAWINGS

FIGS. 1A-C a wearable ear speaker in accordance with one embodiment of the invention.

FIG. 2 shows a side view of the wearable ear speaker mounted to a virtual reality device.

FIG. 3 shows a perspective view of the wearable ear speaker mounted to the virtual reality device.

FIG. 4 shows a top view of the wearable ear speaker mounted to the virtual reality device.

FIGS. 5-6 show front views of the wearable ear speaker mounted to the virtual reality device.

FIG. 7-8 illustrates how the releasable attachment may be attached to a base, in accordance with one embodiment of the invention.

FIG. 9 shows a top view of the slidable mount, in accordance with one embodiment of the invention.

FIG. 10 illustrates the locking mechanism for the releasable attachment to the base, in accordance with one embodiment of the invention

FIGS. 11-22 illustrate further aspects and features of the inventive wearable ear speaker.

### DETAILED DESCRIPTION

In the following description, for purposes of explanation, numerous specific details are set forth in order to provide a thorough understanding of the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not others.

Moreover, although the following description contains many specifics for the purposes of illustration, anyone skilled in the art will appreciate that many variations and/or alterations to said details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

According to one embodiment of the invention, there is disclosed a wearable ear speaker comprising a removable attachment that may advantageously be used for personalization, as will be described.

According to a second aspect of the invention, there is provided a wearable ear speaker comprising this can be adjusted in five different ways to provide an optimal listening experience.

The Aspect of the Wearable Ear Speaker with a Removable Attachment for Personalization:

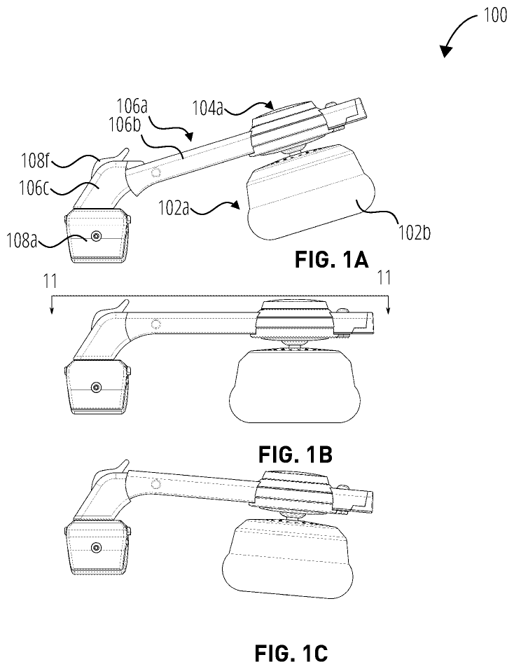

FIG. 1A-C of the drawings each show a side view of the wearable ear speaker 100 in accordance with one embodiment of the invention. As will be seen, wearable ear speaker 100 comprises an earpiece 102a defines a housing 102b within which is housed internal electronics for converting an electrical signal into sound. An arm 106a defines a boom to which the earpiece 102a is mounted via a mount 104a.

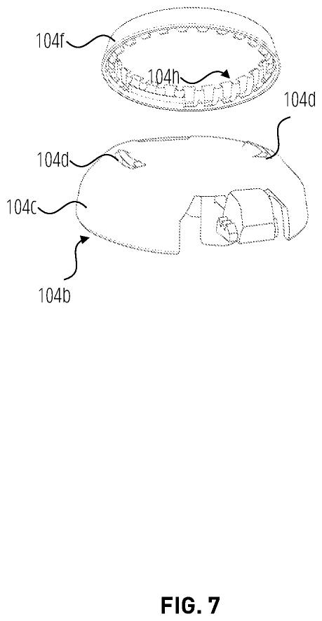

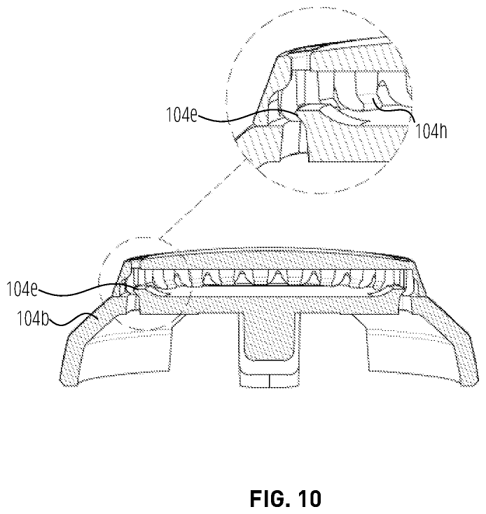

FIG. 7 of the drawings illustrate an embodiment of the mount 104a that advantageously allows the wearer of the earpiece to personalize the device according to his or her preferences. Referring to the drawing, the mount 104a comprises a base 104b to which an attachment 104f can be removably attached, as will be explained. The base 104b is formed with two mounting formations 104d. Each mounting formation 104d is generally arcuate in shape and stands proud of surface 104c of the base 104b, as can be seen in FIG. 7. Each mounting formation 104d defines a lip 104e (see FIG. 10) that performs a role in allowing the attachment 104g to be releasably attached to the base 104b as will be explained.

Referring again to FIG. 7 of the drawings, it will be seen that the attachment 104f is generally cap-shaped having a circular body formed with a peripheral rim that includes a plurality of teeth 104i. In use, as can be seen in FIG. 10, each tooth 104i is curved radially inwardly so that it can engage with the lip 104e of one of the mounting formations 104d.

The attachment 104f is shaped and dimensioned to engage with the base 104b in a snap fit. The attachment 104f and the base 104b may be made of a polymeric or plastics material. In use, the attachment 104f is pushed into contact or engagement with the base 104b so that the teeth 104i that are aligned with each of the mounting formations 104d are resiliently deformed to snap into engagement with the lip 104e of said mounting formation 104d.

In one embodiment, a sufficient number of teeth 104i are provided on the attachment 104f so that no matter the relative orientation of the attachment 104g relative to the base 104b, there will always be alignment or registration of teeth with a mounting formation 104d so that locking of the attachment and the base can occur at said orientation.

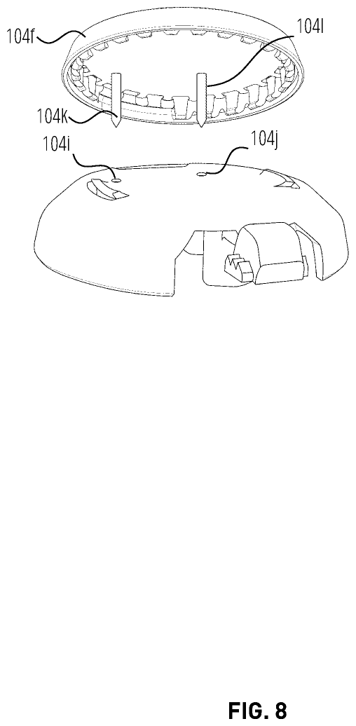

In one embodiment, shown in FIG. 8 of the drawings, the base 104b is formed with two guide apertures 104i that, in use, receive guideposts 104k formed in the attachment 104f. Thus, the base 104b may be releasably attached to the base 104b in a fixed or particular orientation only. Advantageously, this embodiment allows for easy release of the attachment 104f from the base 104b, when, for example, the attachment 104g is formed with a break or cut away (not shown) in the peripheral wall to provide the necessary purchase to allow a prying action to be applied to the attachment 104g to cause its separation from the base 104b.

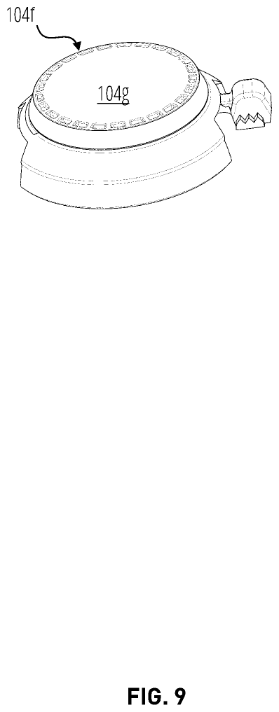

In one embodiment, the attachment 104f may include an operatively outer surface 104g that is circular and generally flat as can be seen in FIG. 9 of the drawings. Said surface can, advantageously, be used to bear indicia for personalization. Examples of indica may include logos, designs, and other markings.

The wearable speaker may be shipped with at least one removable attachment 104f. Said removable attachment may include the logo of a manufacturer of the device, or user-selected or designed indica specified by the user at the time of ordering of the device. In the latter case, the outer surface 104g of the removable attachment 104f is custom printed with the Indica specified by the user.

In some embodiments, a user may purchase a plurality of removable attachments each with a personalized design of choice so that the user may wear the device with a plurality of options for personalization in the manner just described.

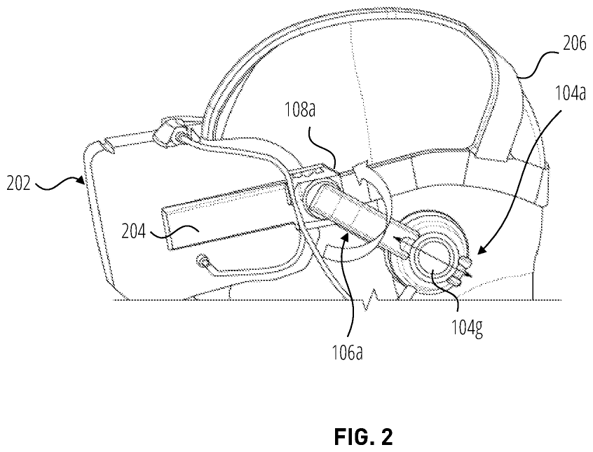

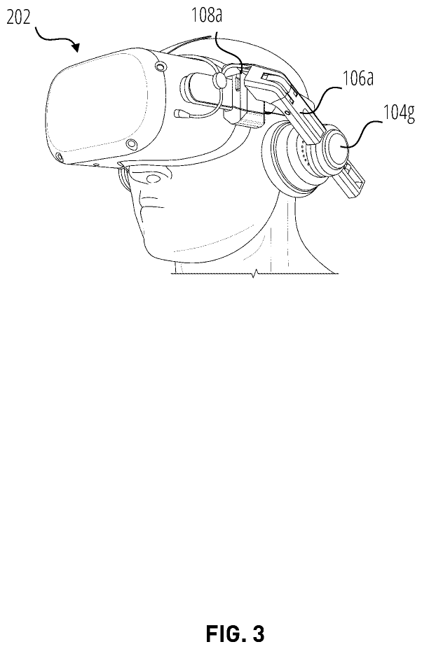

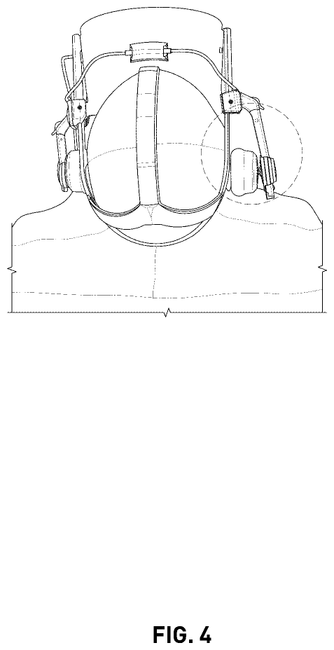

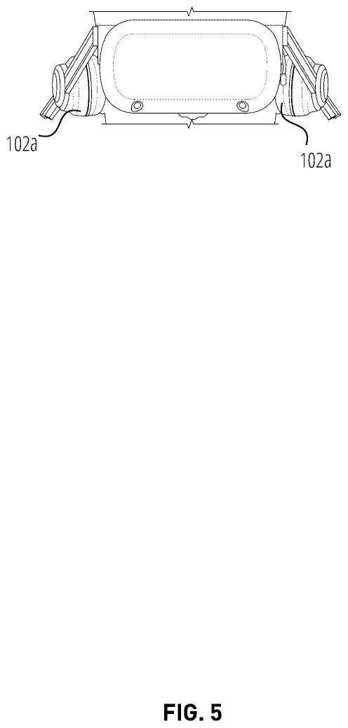

In one embodiment, the inventive wearable ear speaker may be mounted to a secondary device. For example, said secondary device may comprise a virtual reality headset, such as the Oculus series of headsets available from Meta Platforms. Such an embodiment is shown in FIG. 2 of the drawings in which reference 202 generally indicates the virtual reality headset which is shown to include side arms 204 (there is one side arm provided for each side of the head) that never used to secure the device to the head of the user via a strap 206. As will be seen, the indicia-bearing surface 104g is quite visible thereby affording the user the ability to express himself/herself with the personalization options described above.

The Aspect of the Wearable Speaker with a 360° Rotatable Boom

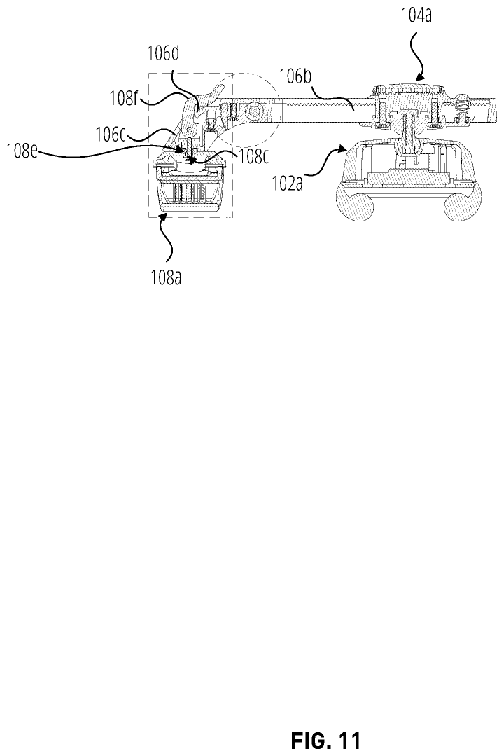

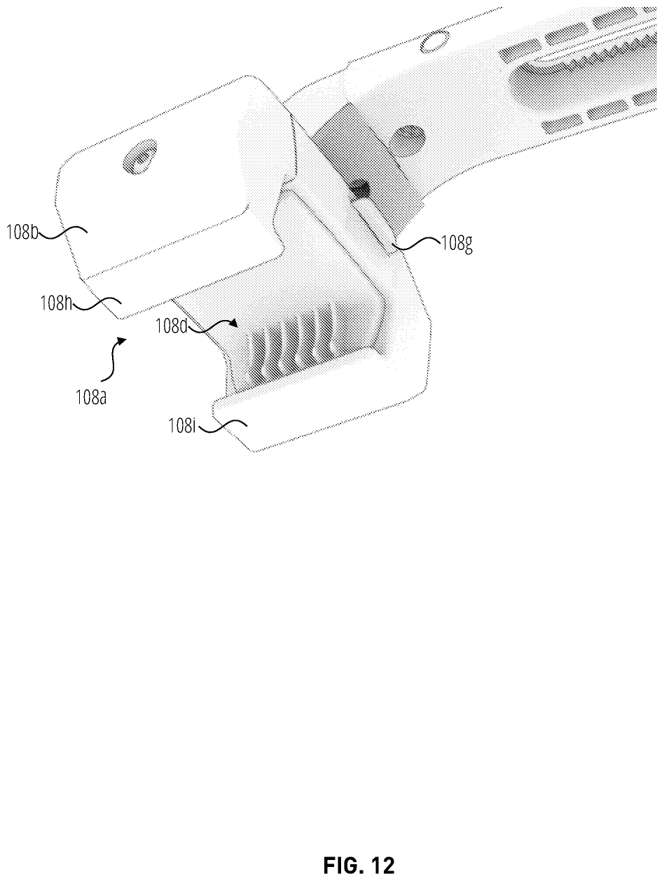

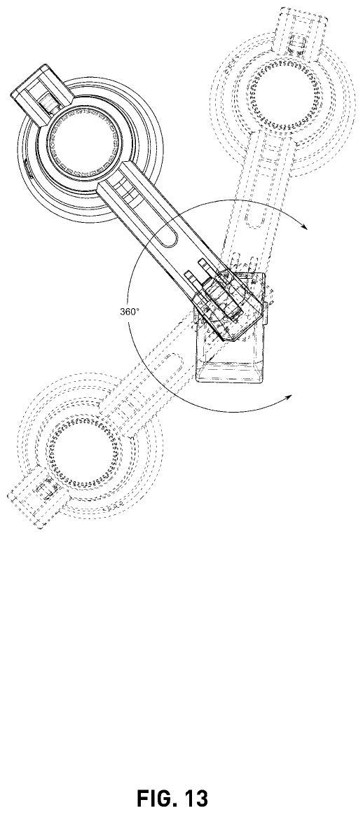

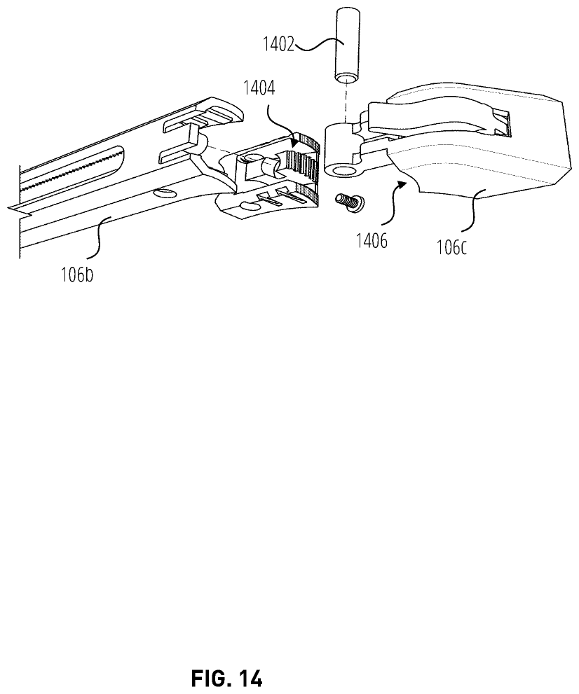

Advantageously, as noted above, the wearable speaker disclosed herein may be mounted to a head mount for a virtual reality device. To facilitate said mounting to the virtual reality device, in one embodiment, the wearable speaker disclosure herein comprises a clamp 108a that can best be seen in FIGS. 11 and 12. As will be seen, the clamp 108a comprises a clamp body 108b that defines a generally U-shaped channel with side arms 108h and 108i. The side arm 108h is movable so that the width of the U-shaped channel can be adjusted. In particular, the side 108 is spring-loaded such that actuation of the release button 108g causes a spring force to be exerted on the arm 108h to cause it to move away from the 108i thereby to increase the width of the channel. As will be seen the sectional drawing of FIG. 11, 108c attaches the body 108b to the second member 106c with little clearance between the two components. A resiliently deformable disc 108e separates the two components and exerts a spring-like force that urges the components away from each other corresponding to a condition in which the two components are rotatable relative to each other through 360° as can be seen in FIG. 13. For locking the clamp 108a to the second member 108c a release arm 108f is pivotally mounted to the second member 108c as can be seen in FIG. 11. The release arm 108f has a notch formed therein that is shaped and the mentioned to engage a latch 106d. In use, locking of the release arm 108f to the latch 106d causes the clamp 108 to be pulled towards the second member 108c resilient disc 108e corresponding to a locked condition in which the relative rotation of the two components is prevented.

In use, the button 108g is actuated to cause the arm 108h to move away from the arm 108i corresponding to an open condition in which the clamp is the side arm 204 for a head mount of the virtual reality device 202. The arm 108h is then pushed towards the arm 108i until the gripping formations 108d of the two arms make firm contact with the side arm 204 corresponding to a locked condition in which the clamp is locked to the side arm 204.

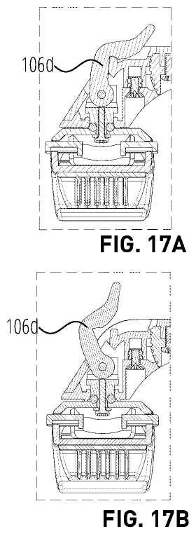

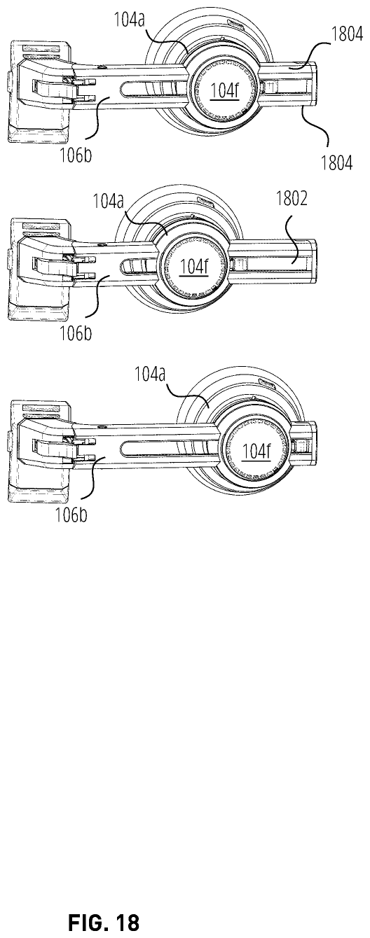

For greater understanding, FIG. 17A the latch in the locked condition, whereas FIG. 17B shows the latch the unlocked condition.

### The Aspect of an Off-Ear Mountable Wearable Speaker:

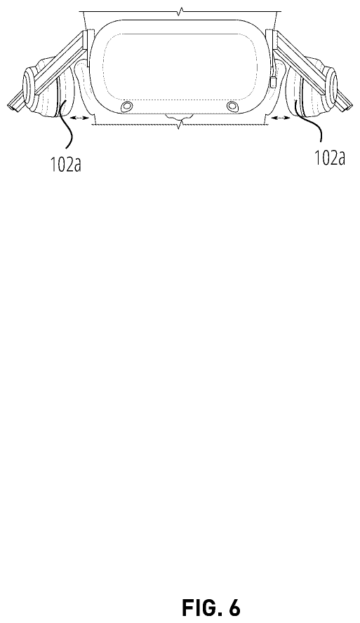

In one embodiment, the wearable speaker disclosed herein may be mounted in a manner in which the earpiece of said device may be in contact with the wearer's ear or may have a clearance with the wearer's ear in a position (off-ear position/condition), as will now be described. The boom defined by the pivot arm 106a comprises two components mounted to support pivotal motion between them. In particular, these components comprise a first member 106b and a second member 106c, as can be seen in FIG. 1 of the drawings. A control mechanism controls the clearance of the earpiece relative to the wearer's ear. In one embodiment, the control piece is defined by a pivot pin 1402 that secures the first member 106b to the second member 106c. The first member 106b has a rolling surface 1404 that is in fictional contact with a complementary stop 1406 at an end of the second member 106c. Said rolling surface 1404 and stop 1406 may be made of a material selected from the group consisting of rubber, silicone thermoplastic elastomer, and low-density polyethylene. There may be zero clearance between the rolling surface 1404 and the stop 1406, and friction between the materials of these components is such that the first and second members may be pivoted relative to each other between a maximal condition that corresponds to a position in which the earpiece is at a maximum possible distance away from the ear, and to a minimal condition in which there is no relative pivoting between the first and second members, corresponding to condition in which the earpiece is in contact with the wearer's ear. The on-ear position is illustrated in FIG. 6, and the off-ear position illustrated in FIG. 7.

In one embodiment, the rolling surface may be undulating such that only certain portions of said surface come into contact with the stop as the rolling surface moves during actuation of the control mechanism. Thus, less material of the rolling surface is actually in contact with the stop thereby allowing less force to cause the relative pivoting motion between the two components.

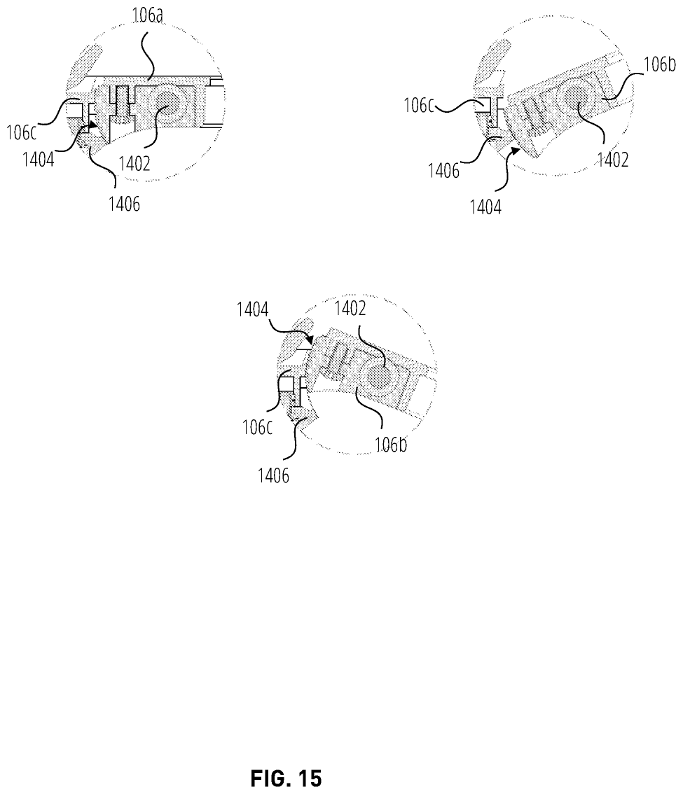

For greater understanding of the pivoting motion, FIG. 15 shows the relative position (in cross-section) of the first and second members of the arm that defines the boom corresponding to various degrees of the relative pivotal condition between the two members.

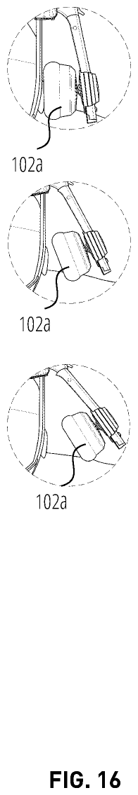

FIG. 16 also illustrates the on and off ear positions, in accordance with one embodiment of the invention.

The Aspect of the Wearable Ear Speaker with a Slidable Mount:

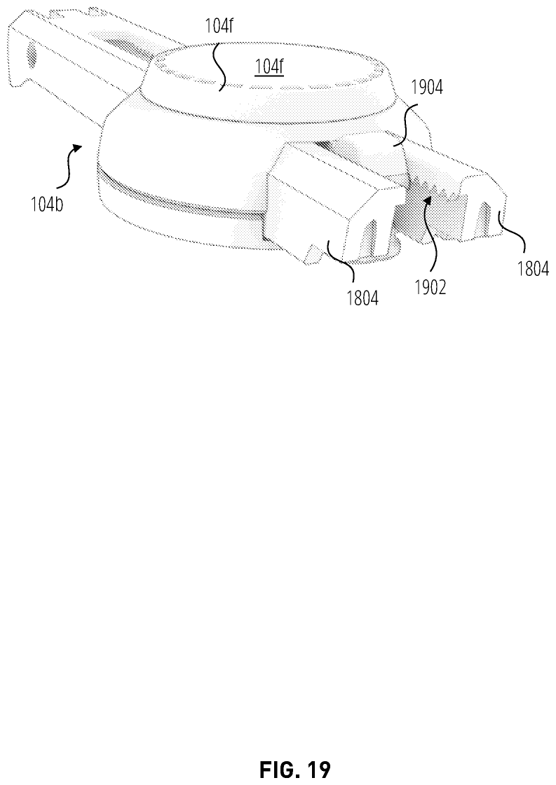

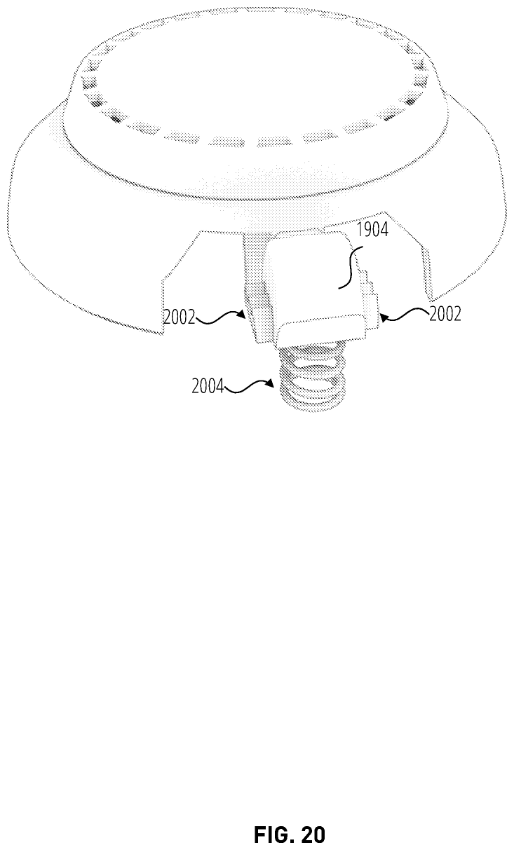

The mount 104a may, in one embodiment, be a slidable mount, as will now be explained. Referring to FIG. 8, it will be seen that the second member 106b of the arm that defines the boom has an elongate slot 1802 formed therein such that the member 106b defines a longitudinal track comprising rails 1804. The base 104b of the mount 104a is mounted within the longitudinal track and is slidable within the track to a desired position by the wearer. The mount 104a is thus a slidable mount and is releasably lockable via a locking mechanism at the desired position, as will now be described. In one embodiment, said locking mechanism comprises a button 1904 formed in the base 104b. The button 1904 includes side teeth 2002 (see FIG. 20) that are shaped and dimensioned to engage with matching teeth 1902 formed along an underside of the entire length of the rails 1804, as can be seen in FIG. 19. In use, a spring 2004 located below the button 1904 exerts a force on the underside of the button because it to move upward to a condition in which the teeth 2002 of the button 1904 are normally engaged with the teeth 1902 of the rails 1804, corresponding to a locked condition of the locking mechanism. For unlocking, finger pressure is exerted downward plea upon the button 1904 which causes the button to move in a downward direction against the force of the spring 2004 thereby to cause teeth 1902 to become disengaged from the teeth 2002 corresponding to the unlocked condition of the locking mechanism.

The Aspect of the Wearable Ear Speaker with a Pivotable Earpiece

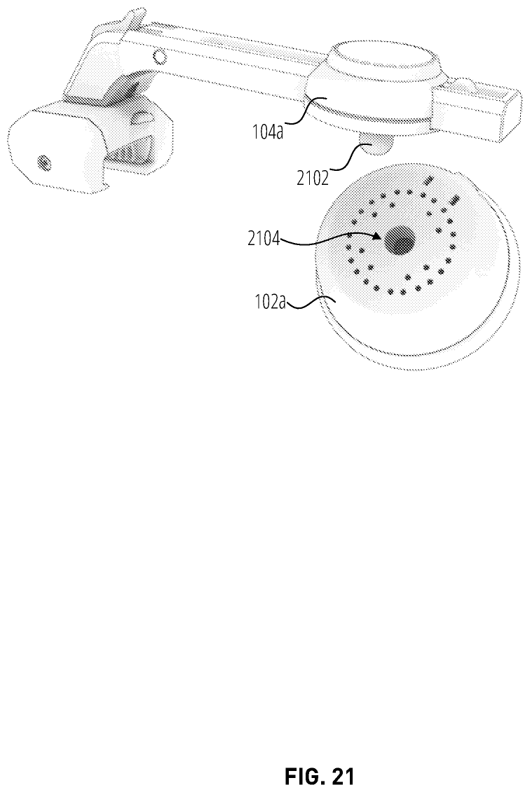

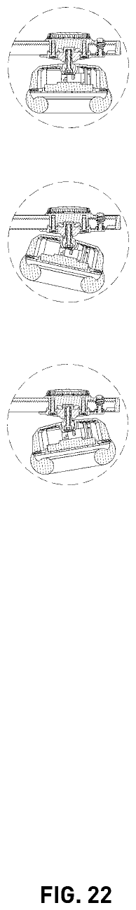

In one embodiment, the earpiece 102a is mounted to the slidable mount 104a via a ball and socket arrangement, which will now be described with reference to FIG. 21 of the drawings. For this embodiment, the slidable mount 104a is formed with a ball 2102 formed its operative underside. Said ball is shaped and dimensioned to be received in a complementary socket formed in the earpiece 102a in a tight fit. In one embodiment, the ball-and-socket may be formed made of a material selected from the group consisting of rubber, silicone thermoplastic elastomer, and low-density polyethylene. The tightness of the fit between ball-and-socket is such that the earpiece may be articulated relative to the slidable mount from a first position to a second position thereby to alter the relative tilt between the two components such that the tilt of the second position is retained or maintained due to the tightness of the fit. Thus, adjustability of the tilt between the earpiece and the slidable mount is achieved. FIG. 22 of the drawings shows the positions of relative tilt between the earpiece and the slidable mount to enhance understanding of this feature.

To the extent that the term “include,” “have,” or the like is used in the description or the claims, such term is intended to be inclusive in a manner similar to the term “comprise” as “comprise” is interpreted when employed as a transitional word in a claim. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples, and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

1. A wearable ear speaker, comprising:
an earpiece comprising a body defining a housing, and internal electronics mounted within said housing, wherein said body comprises a removable attachment comprising an operatively outer surface for bearing indicia;
an arm defining a boom for the earpiece; and
a mounting formation for mounting the earpiece to said boom.

2. The wearable ear speaker of claim 1, wherein said removable attachment is disk-shaped.

3. The wearable ear speaker of claim 1, removable attachment attaches to the body in a snap fit.

4. The wearable ear speaker of claim 3, wherein to achieve set snap fit, the removable attachment comprises a plurality of teeth.

5. The wearable ear speaker of claim 4, wherein the body comprises complementary engagement formations for engaging with the teeth.

6. The wearable ear speaker of claim 1, wherein said complementary engagement formations and said teeth are resiliently deformable.

7. The wearable ear speaker of claim 1, the removable attachment bears indicia selected from the group consisting of logos, artwork, graffiti, names of people, and emojis.

8. A wearable ear speaker, comprising:
an earpiece comprising a body defining a housing, and internal electronics mounted within said housing for converting an electrical signal into sound;
an arm defining a boom for the earpiece; and
a slidable mount for mounting the earpiece to the arm.

9. The wearable ear speaker of claim 8, wherein said arm defining the boom comprises a body shaped to define a longitudinal track.

10. The wearable ear speaker of claim 9, wherein said slidable mount comprises a base that a slidable within the longitudinal track.

11. The wearable ear speaker of claim 10, wherein said base comprises a releasable locking mechanism to lock said base relative to the longitudinal track.

12. The wearable ear speaker of claim 11, wherein said releasable locking mechanism comprises a button formed with a plurality of teeth, and a biasing mechanism to bias the teeth into engagement with complementary teeth of the boom.

13. The wearable ear speaker of claim 12, wherein said biasing mechanism comprises a spring mounted to urge the teeth of the button into engagement with the teeth of the boom.

14. The wearable ear speaker of claim 8, wherein the slidable mount comprises a removable attachment bearing indicia selected from the group consisting of logos, artwork, graffiti, names of people, and emojis.

15. A wearable ear speaker, comprising:
an earpiece comprising a body defining a housing, and internal electronics mounted within said housing for converting an electrical signal into sound;
a mounting arm defining a boom for the earpiece comprises a control mechanism to control a clearance of the earpiece relative to a wearer's ear;
a mount for mounting the earpiece to the arm; and
a rotatable clamp for securing said mounting arm to the head mount for a virtual reality device.

16. The wearable ear speaker of claim 15, wherein said mounting arm comprises first and second members.

17. The wearable ear speaker of claim 16, wherein said control mechanism is defined by a pivot pin securing said first and second members together; and a rolling surface at an end of the first member configured to be in frictional contact with a complementary stop at an end of the second member such that frictional contact between the rolling surface and the stop is sufficient to lock the first and second members together in a relative pivot condition defined between zero pivot condition and a maximum pivot condition.

18. The wearable ear speaker of claim 17, wherein said zero pivot condition corresponds to a condition in which the first and second members are not pivoted relative to each other, a condition that corresponds to a position in which the earpiece is in contact with the wearer's ear.

19. The wearable ear speaker of claim 18, wherein said maximum pivot condition corresponds to a condition in which this is the first and second members are pivoted relative to each other to a maximal condition that corresponds to a position in which the earpiece is a maximum possible distance away from the wearer's ear.

20. The wearable ear speaker of claim 19, wherein said rolling surface is undulating such that only certain portions of said surface come into contact with the stop as the rolling surface moves relative to the stop during actuation of the control mechanism.

21. The wearable ear speaker of claim 15, wherein said rolling surface are made of a material selected from the group consisting of rubber, silicone thermoplastic elastomer, and low-density polyethylene.
